(19) United States
(12) Patent Application Publication
(10) Pub. No.: US 2021/0268321 A1
(43) Pub. Date: Sep. 2, 2021

(54) SYSTEM FOR FORMING AND DELIVERING FLUIDS IN GEL FORM BY MEANS OF A LANCE WITH A VENTURI DEVICE

(71) Applicant: Juan Jose SORIANO AZORIN, Yecla (Murcia) (ES)

(72) Inventor: Juan Jose SORIANO AZORIN, Yecla (Murcia) (ES)

(21) Appl. No.: 17/258,597

(22) PCT Filed: Jul. 9, 2018
(86) PCT No.: PCT/ES2018/070492

§ 371 Date: Jan. 7, 2021

(51) Int. Cl. A62C 5/00; A62C 17/00; A62C 5/033; B05B 7/04

(52) U.S. Cl. CPC A62C 5/002; B05B 7/04; A62C 5/033; A62C 17/00

(57) ABSTRACT

A system that allows a gel to be formed by mixing the solid precursor of the gel and water and spraying same onto surfaces is provided. The system includes: a conveyor for the added gelling agent or solid; a pair of openings on the sides of the conveyor tube; a dosing device located after the openings, which distributes the amount of solid added to the conveyor; a Venturi shut-off valve; a mains connection which allows water to enter the system when the water shut-off valve is opened; a Venturi inlet pipe which connects to the Venturi chamber through which the water passes; a Venturi outlet pipe through which the water passes with the solid; and a lance for discharging the gel produced by mixing the water and the solid.

### OBJECT OF THE INVENTION

The present invention discloses a system that allows a gel to be formed by mixing the solid precursor of the gel and water and spraying same onto surfaces with a greater speed and range than the lances known in the state of the art.

### BACKGROUND OF THE INVENTION

The present invention relates to a system for forming a gel from powder and a fluid, preferably water, and at the same time spraying it outwards by means of a lance which includes a Venturi device; the invention allows, in addition to forming the product “in situ”, the resulting product to be sprayed in gel form at a distance and power greater than any lance described in the state of the art.

Water lances, formed by a main body and a head, which have an opening and closing control that allows the intensity of the water flow to be regulated, are known. This type of lance allows water to be sprayed in different ways by varying the position of the head.

Normally, this head usually consists of a movable cylindrical part which constitutes the outlet mouth of the lance, such that by turning it, and depending on the position chosen, one type of water spray or another can be used. The water can be sprayed, as needed, in the form of a solid jet, atomisation or mist.

Furthermore, said lances have another series of devices, such as self-cleaning mechanisms which allow the outlet of the water from the lance to be kept free simply by varying the position of the head, or connections with adapters which allow them to be connected to any type of hose.

Despite the many advantages shown by the lances on the market, it has been found that there is a possibility that, either by user error or by an impact or fall of the lance, the head of said lance changes position and, therefore, the water spray mode also changes.

European patent EP0451046 describes a lance for delivering fluids such as pulp or liquid or pasty products obtained by mixing solid and liquid products, and eventually additives intended to reduce viscosity, and such that it is able to be set in motion by means of pumps. In particular, it can be a coal dust with added water, sprayed by the ejecting lance into a boiler to be burned. The feature of a pulp is that it is a product that is often very viscous or pasty and usually very abrasive, which is difficult to handle by means of pumps, generally of the concrete pump type, and therefore cannot be atomised with the same methods as those used for less viscous fluids, such as water or “fiul” for example. In particular, the speed with which the pulp is conveyed is generally comprised between 0.1 and 2 m/sec.

In the state of the art there is a known pulp spraying lance or ejector, described in document U.S. Pat. No. 3,840,181 which comprises the following elements that are common to it: a central tube that sprays longitudinally without decreasing in cross section according to a lance axis in order to convey a pulp from a pulp inlet formed on an inlet side of this tube to a lance outlet formed at one end of this tube, pulp supply means for supplying this inlet with pulp, a gas conduit, gas supply means for introducing a pressurised motor gas into the inlet portion of this gas conduit and dispersion openings which cross through the wall of the central tube in order to introduce the motor gas into this tube from the gas conduit in order to disperse and accelerate the pulp with the aim of it forming a jet at the outlet of this tube. In this first known lance or ejector, the gaseous jets are radial. In a second known spraying lance, according to document JP-A-61-83817, the gaseous jets form an acute angle with the shaft of the lance. In both cases, these jets disintegrate the column of pulp and give it a strong axial speed. Thus, they create a long and concentrated jet. The results obtained with such lances degrade very quickly as soon as the water content is lowered and the pulp becomes very viscous.

Other pulp lances or ejectors are also known which inject air through an annular conduit at the end thereof. This air is intended to penetrate the jet of pulp and disperse it. Such lances are not adapted to high viscosities, as the air does not penetrate the pulp sufficiently and a poorly dispersed jet of pulp is obtained.

Document WO2015082751 discloses an integrated screen nozzle for self-protection, devised for the creation of an integrated safety zone and designed for self-protection, the protection and safeguarding of people and property in situations of risk, derived from entrapment in fire emergencies of all kinds: forest, interface, agricultural, urban and industrial, it is characterised by the fact that it comprises a connection (1) for coupling to the corresponding supply of water for extinction, and next to which connector (1) there lies a flow meter (2) which measures the flow of fluid, followed by a dispenser (5) of chemical agents (retardant or humectant), connected, via a conduit (4) to the corresponding deposit (3) containing the chemical agent, and there lying next to the dispenser (5) a connecting tube (6) between the same and a protection-projection screen (7), of semicircular configuration and with a slight warping (7), complemented with some anchorage points (8) for support upon the ground, these nt anchorage points (8) being adjustable in height so as to allow the angle of spraying of the fluid (water) to be changed and oriented, with respect to the horizontal plane of the ground, with the particular feature that upon the chemical agent deposit (3), there are included externally a support (12) which, at its upper part, forms a handle (13), the cited deposit (3) including in its upper part a lid (9) for closure, as well as housing (10) for a GPS geolocator.

The Spanish utility model ES1160659U discloses a lance for extinguishing a fire in a space (A) closed by at least one closing element (P), comprising: at least one first conduit (20) with a first inlet (21) which can be connected to a first supply line (F1) for the pressurised fluid (W) and a first outlet (22) for the same (W); a first control lever (12) which acts on said at least one first conduit (20) to allow the operator to control the selective flow of pressurised fluid (W) therethrough; at least one second conduit (30) with a second inlet (31) which can be connected to a second supply line (F2) for the abrasive powder (AP) and a second outlet (32) for the same (AP); a second control lever (62) which acts on said at least one second conduit (30) to allow the operator to control the selective flow of the abrasive powder (AP) therethrough; at least one first nozzle (100) which has a pair of first inlet ports (101, 102) respectively connected to said first outlet (22) of said at least one first conduit (20) and to said second outlet (32) of said second conduit (30) and a first outlet port (104) configured to spray a concentrated jet of the mixture (W+AP) thereof, said at least one first nozzle (100) including mixing means with a Venturi effect (103) in order to mix the pressurised fluid (W) and the abrasive powder (AP) when said second control lever (62) controls the flow of the latter through said at least one second conduit (30); wherein said lance comprises at least one first handle (11) which can be grasped by an operator, the latter comprising said first and second control levers (12, 62); wherein said first and second control levers (12, 62) are located close to each other such that the operator can actuate said first control lever (12) and said second control lever (62) with the same hand used to grab the lance (10).

The present invention improves the current state of the art in the delivery of a gel, since in addition to forming the gel “in situ” within the system, it sprays it with a greater range than the devices known in the state of the art.

### DESCRIPTION OF THE DRAWINGS

To complement the description provided herein and for the purpose of helping to better understand the features of the invention according to a preferred practical embodiment thereof, said description is accompanied by a set of FIGURE constituting an integral part of the same, wherein the following is depicted with an illustrative and non-limiting character:

FIG. 1 shows a view of the system indicating the constituent elements thereof.

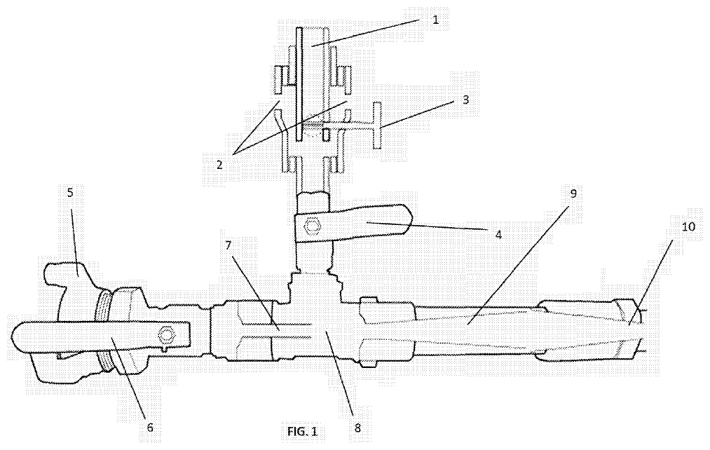

### DESCRIPTION OF THE INVENTION

The system for forming gel and delivering it by means of a lance with a Venturi device allows a solid consisting of the gelling agent and water or a suitable solvent to be mixed within the system, all this thanks to the pressure exerted by the water flow which is introduced into the system; furthermore by means of a Venturi device incorporated into the delivering lance, the formed gel can be sprayed at distances greater than any lance known in the state of the art, the system allows the adequate dosing of the product and a more effective atomisation, since the outlet mouth of the device is free, nozzles being able to be adapted for the atomisation thereof or in the shape of a fan.

### PREFERRED EMBODIMENT OF THE INVENTION

The system of the present invention comprises a tube that acts as a conveyor (1) for the solid or gelling agent, wherein the solid product falls due to gravity when added through the top of said conveyor (1). The conveyor (1) is inserted between a pair of openings (2) on the sides of said conveyor tube (1) and ends in a dosing device (3) which allows the controlled distribution of the solid which is located after the openings (2). When the Venturi shut-off valve (4) is opened and there is pressurised water in the hose, the Venturi chamber (8) absorbs air, since a vacuum is caused due to the fact that the only inlet is through the Venturi shut-off valve (4). When the Venturi shut-off valve (4) is opened, the product falls and the air that enters through the inlet openings (2) is what transports them to the Venturi chamber (8), the system is connected to the water mains through the mains connection (5) which allows water to enter when the water shut-off valve (6) is opened and sending it to the Venturi inlet pipe (7) where the water passes into the Venturi chamber (8) and by means of an inverted cone structure it passes to the Venturi outlet (9) where the water mixed with the solid in the same pressure thereof is grouped and it shoots it by means of the lance (10) in gel form. When a conventional Venturi device is used, 20 to 25% of water pressure is lost, in this case the outlet pressure of the water is not lost through the lance because the negative pressure is counteracted by absorption of the Venturi with the air inlet through the openings of the conveyor, giving positive pressure to the flow of the water stream. It is also affected by the fact that the outlet of the lance is free since it is a cone with the narrow portion facing outwards, through which it collects the water flow without obstacles slowing it down.

When passing the Venturi shut-off valve (4), the product absorbs water, for which reason the product is mixed at a high pressure and then it is shot, turning into a gel at the Venturi outlet (9). In the conical structure just at the Venturi outlet (9), the powder is mixed with the water and the gel is formed, for which reason the gel is discharged from the tip of the lance (10). This is why the system is a Venturi lance tip. The element (9) acts as an absorbent and is where the gel is formed. When the water enters from a pipe with a smaller cross section to a pipe with a larger cross section in a conical shape, a vacuum is produced and that is what absorbs the air that enters through the openings (2) which in turn is what carries the powder to the Venturi chamber (8).

The conveyor (1) is located in the top of the Venturi shut-off valve (4) and thanks to the air inlet openings (2) for entering air, it allows the product to go downwards by gravity, since if these inlet openings (2) did not exist, so much product would be sucked in that the Venturi chamber (8) would become clogged and would not be able to absorb all the product and the negative pressure would stop the product from leaving due to the vacuum produced by the Venturi.

The system of the present invention allows, in addition to mixing the precursor components of the gel, sending them by means of a lance at high speed and with a greater range than the lances known in the state of the art. As a result, a combined system is obtained which allows the fluidisation of gel particles that can be used for various activities, in particular extinguishing fires.

From the foregoing it is deduced that the system for forming and delivering fluids in gel form by means of a lance with a Venturi device of the present invention comprises a tube that acts as a conveyor (1) for the added gelling agent or solid; a pair of openings (2) on the sides of said conveyor tube (1); a dosing device (3) for dosing the amount of solid added to the conveyor (1) located after the openings (2); a Venturi shut-off valve (4) to prevent the solid from entering the Venturi chamber (8); a mains connection which allows water to enter the system when the water shut-off valve (6) is opened; a Venturi inlet pipe (7) which connects to the Venturi chamber (8) through which the water passes; a Venturi outlet pipe (9) through which the water passes with the solid; and a lance (10) for discharging the gel produced by mixing the water and the solid.

The substantial improvement introduced by the application of the present invention is the speed and performance in forming the extinguishing compound for fighting fires from direct or indirect attack with water sprays, wherein the extinguishing mixture is being formed at the time it is used, the extinguishing mixture being prepared in just a few seconds in the system.

By using these products in direct attack and continuous mixing at the water outlet, an immediate cooling and suffocating effect could never be achieved, since the dust and water will drain without adhering to the fuel surfaces and the gel effect will be achieved once the water-dust has already drained and are scattered in the fuels.

1. A system for forming and delivering fluids in gel form by means of a lance with a Venturi device comprising:
a tube which acts as a conveyor for the added gelling agent or solid;
a pair of openings on the sides of said conveyor tube;
a dosing device located after the openings, which distributes the amount of solid added to the conveyor;
a Venturi shut-off valve;
a mains connection which allows water to enter the system when the water shut-off valve is opened;
a Venturi inlet pipe which connects to the Venturi chamber through which the water passes;
a Venturi outlet pipe through which the water passes with the mixed solid; and
a lance for discharging the gel produced by mixing the water and the solid.

2. The system for forming and delivering fluids in gel form by means of a lance with a Venturi device according to claim 1, wherein there is an inverted cone structure between the Venturi chamber and the Venturi outlet.

3. The system for forming and delivering fluids in gel form by means of a lance with a Venturi device according to claim 1, wherein the inlet pipe has a smaller cross section than the Venturi outlet pipe.
